(19) United States
(12) Patent Application Publication
(10) Pub. No.: US 2009/0328005 A1
(43) Pub. Date: Dec. 31, 2009

(54) DEBUGGER CALL STACK CACHING

(75) Inventor: Gregory Bernard Miskelly, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/163,296

(22) Filed: Jun. 27, 2008

(51) Int. Cl. G06F 11/36; G06F 3/048

(52) U.S. Cl. 717/125; 717/124

(57) ABSTRACT

A debugger backend computes and stores a previous call stack of multiple threads of a debuggee process based on previous call stack information provided from a debugging agent. The debugger backend stores a first hash of threads of the debuggee process and stack memory of the previous call stack. The debugger backend sends the first hash to the debugging agent in response to a request of the current call stack from a debugger user interface (UI), and provides the previous call stack to the debugger UI in response to the debugging agent indicating that that first hash matches a second hash of thread registers of the debuggee process and stack memory of the current call stack.

### BACKGROUND

Debuggers have typically focused on visualizing one thread of execution at one given time. This type of debugger worked well with software programs written to run sequentially. However, there has been a recent shift away from ever increasing single-processor clock rates towards an increase in the number of processors available in a single computer resulting in a corresponding shift away from sequential execution towards parallel execution. Software developers want to take advantage of improvements in computer processing power to enable their software programs to run faster as new hardware is adopted. With parallel hardware, software developers arrange for one or more tasks of a particular software program to be executed in parallel (also referred to as concurrently), so that the same logical operation can utilize many processors at one time to thereby deliver better performance as more processors are added to the computers on which such software runs. Accordingly, more programs will be written with multiple threads.

Software developers want their development environment to properly aid them in writing these multi-threaded programs. As a result, it is desirable for debuggers to start visualizing multiple threads. Visualizing multiple threads, however, can be extremely expensive for debuggers, because the time taken by the debugger user interface (UI) to update after stopping the debuggee program linearly increases with the number of threads in the debuggee program. Furthermore, many programs today have a large number of threads.

Debugger stepping performance can be significantly degraded by having a large number of threads in a debuggee program, because users can frequently step through large amounts of code to debug a program. At each step, the debugger updates the debugger UI. If this update of the UI is a slow operation, users can become distracted and frustrated. Typically, most of the “per-thread” time cost is walking and analyzing the call stack of the debuggee program. With programs having a large number of threads, it typically takes a large amount of time to obtain the call stacks on all threads, which is therefore, a significant barrier to enabling cross-thread visualization in the debugger.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one embodiment, a debugger backend computes and stores a previous call stack of multiple threads of a debuggee process based on previous call stack information provided from a debugging agent. The debugger backend stores a first hash of threads of the debuggee process and stack memory of the previous call stack. The debugger backend sends the first hash to the debugging agent in response to a request of the current call stack from a debugger user interface (UI), and provides the previous call stack to the debugger UI in response to the debugging agent indicating that that first hash matches a second hash of thread registers of the debuggee process and stack memory of the current call stack.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating a computer system according to one embodiment.

FIG. 2 is a block diagram of one embodiment of a debugger system computer including a debugger system application interfacing with a debuggee process computer including a debugging agent and a debuggee process.

FIG. 3 is a flow diagram illustrating one embodiment of a method of debugging a debuggee process performed by a debugger backend.

FIG. 4 is a flow diagram illustrating one embodiment of a method performed by a debugging agent.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

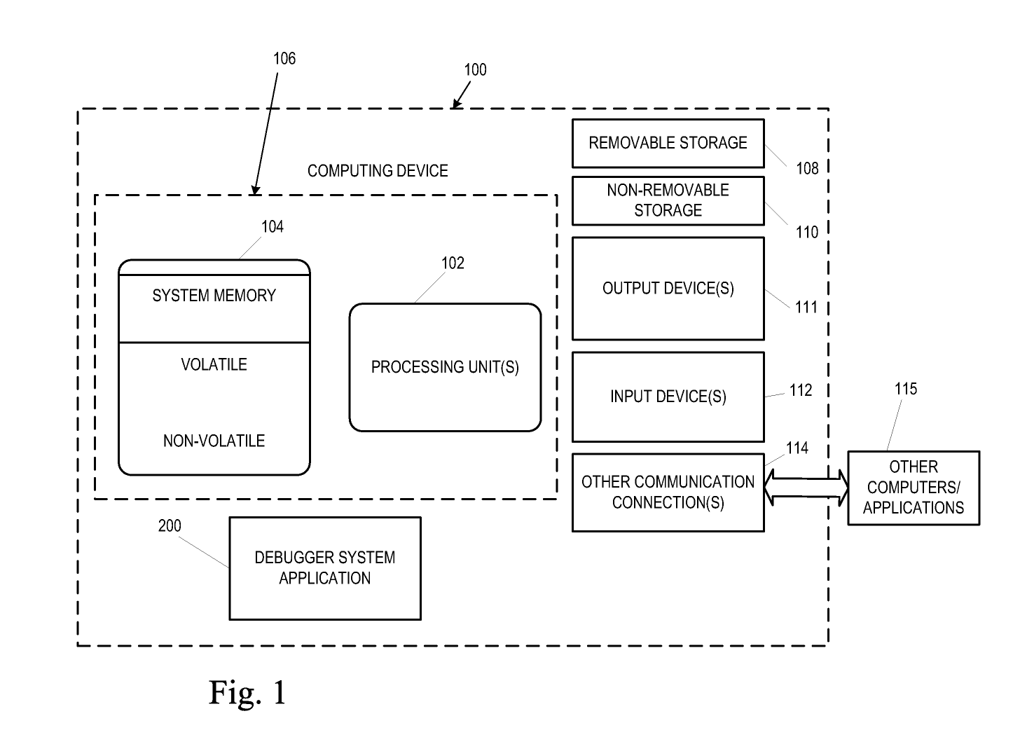

As illustrated in FIG. 1, an exemplary computer system that can be employed to implement one or more parts of an example debugger system and/or an example debugging agent and/or an example debuggee process includes a computing device, such as computing device 100. In a basic configuration, computing device 100 typically includes processing unit(s) (i.e., processor(s)) 102 and memory 104. Depending on the exact configuration and type of computing device, memory 104 may be volatile (such as random access memory (RAM)), non-volatile (such as read only memory (ROM), flash memory, etc.), or some combination of the two. This basic configuration is illustrated in FIG. 1 by dashed line 106.

Computing device 100 may also have additional features/functionality. For example, computing device 100 may also include additional storage (removable and/or non-removable) including, but not limited to, magnetic or optical disks, or tape, or flash storage devices. Such additional storage is illustrated in FIG. 1 by removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) flash drive, flash memory card, or other flash storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. Computing device 100 may also include input device(s) 112, such as keyboard, pointing device (e.g., mouse), pen, voice input device, touch input device, etc. Computing device 100 may also include output device(s) 111, such as a display, speakers, printer, etc.

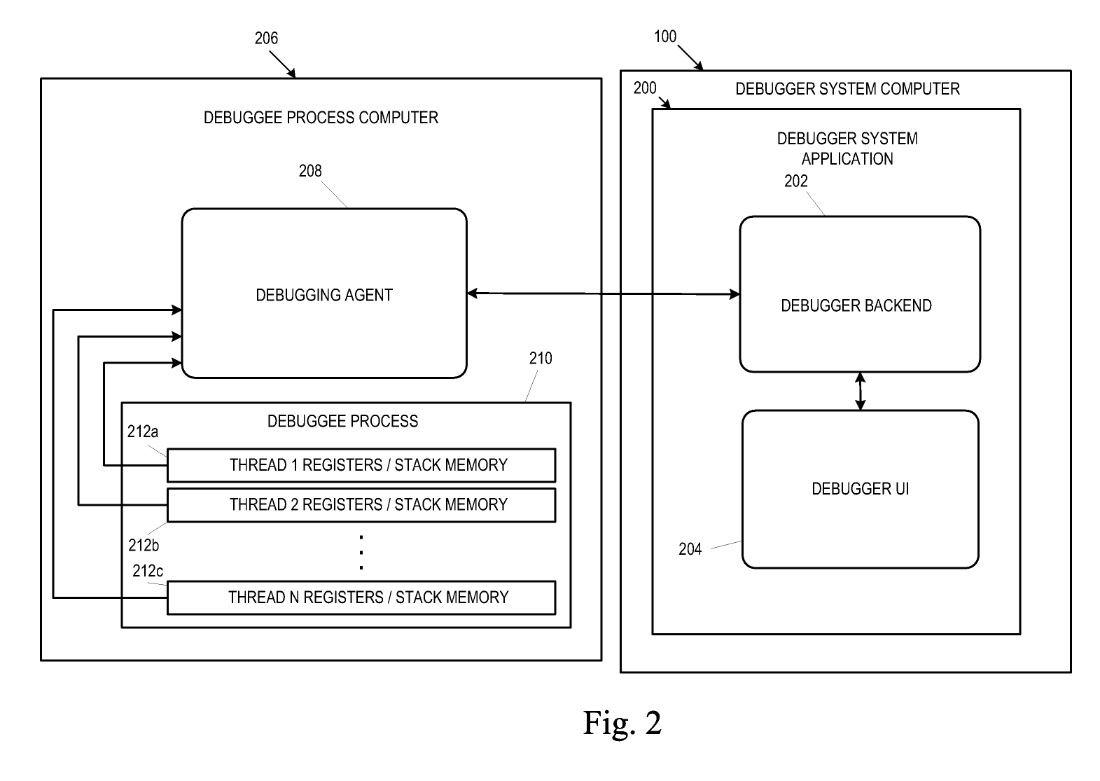

In one implementation, computing device 100 includes a debugger system application 200. Debugger system application 200 is described in further detail below with reference to FIG. 2.

One embodiment of a debugger system computer 100 (e.g., computing device 100 illustrated in FIG. 1) comprising a debugger system application 200 interfacing with a debuggee process computer 206 (e.g., a computing device similar to computing device 100 illustrated in FIG. 1) comprising a debugging agent 208 and a debuggee process 210 is illustrated in FIG. 2.

Debugger system application 200, debugging agent 208, and debuggee process 210 can be implemented on any suitable type and suitable number of computer systems, such as computing device 100 illustrated in FIG. 1. In one embodiment, debugger system application 200 is one of the application programs that reside on computing device 100, debugging agent 208 is one of the application programs that reside on debuggee process computer 206, and debuggee process 210 is one of the application programs that reside on debuggee process computer 206. Debugger system application 200, however, can alternatively or additionally be embodied as computer executable instructions on one or more computers and/or in different variations than illustrated in FIG. 1. Alternatively or additionally, one or more parts of debugger system application 200 can be stored in system memory 104, on other computers/applications 115, or other such suitable variations for running a debugger system application.

In one embodiment, debugging agent 208 is on a debuggee process computer 206 which is remote from debugger system computer 100 which includes debugger system application 200. However, in other embodiments, debugging agent 208 and/or debuggee process 210 resides on the same computer as debugger system application 200.

Embodiments of debugger system application 200, debugging agent 208, and debuggee process 210 are described herein in the general context of computer-executable instructions, such as program modules, being executed by a computer. Generally, program modules include routines, programs, objects, components, data structures, etc. that perform particular tasks or implement particular abstract data types. Embodiments may be practiced in distributing computing environments where tasks are performed by remote processing devices that are linked through a communications network. In a distributed computer environment, program modules may be located in both local and remote computer storage media including media storage devices.

In one embodiment, debugger system application 200 includes a debugger backend 202 and a debugger user interface (UI) 204. Debugger UI 204 is configured to allow a user to interact with debugger system application 200. Debugger UI 204 is configured to request a current call stack of multiple threads of debuggee process 210. In the embodiment illustrated in FIG. 2, debuggee process 210 includes threads 1, 2, . . . N which correspondingly have thread registers and stack memory indicated at 212a, 212b, . . . 212c.

Generally, processor based systems execute processes that include a sequence of instructions that is executable by hardware threads. The hardware threads typically represent execution cores of one or more processors of the processor based system. For example, in computing device 100 and debuggee process computer 206, one or more processing units (e.g., processing units 102) include hardware threads which are each configured to access and execute process instructions stored in system memory (e.g., system memory 104) as a process.

In one embodiment, some of the application programs on computing device 100, such as debugger system application 200, are configured to present a UI that is configured to allow a user to interact with the application program in some manner using some type of input device. Debugger UI 204 is such a user interface which can be part of debugger system application 200 or some other application program running on computing device 100 or on other computers/applications 115. In one embodiment, debugger UI 204 is a visual display that is capable of receiving user input and processing that user input in some way. Embodiments of debugger UI 204 can, for example, include one or more user interactable components (e.g., links, buttons, or controls) that can be selected (e.g., clicked) by a user via a pointing device. In one embodiment, a user may enter commands and information into computing device 100 via input devices 112.

Debugger backend 202 is configured to compute a previous call stack of multiple threads of debuggee process 210 based on previous call stack information provided from debugging agent 208. Debugger backend 202 is configured to store (e.g., cache) the computed previous call stack. Debugger backend 202 is configured to store a first hash of thread registers of debuggee process 210 and stack memory of the previous call stack. In one embodiment, debugger backend 202 is configured to compute the first hash of thread registers of the debuggee process and stack memory of the previous call stack. In one embodiment, debugger backend 202 is configured to receive from debugging agent 208 the first hash of thread registers of the debuggee process and stack memory of the previous call stack from the debugging agent.

In one embodiment, debugger backend 202 is configured to receive the request of the current call stack from debugger UI 204. Debugger backend 202 is configured to send the first hash of thread registers of the debuggee process and stack memory of the previous call stack to debugging agent 208 in response to the request of the current call stack from debugger UI 204.

In one embodiment, debugger backend 202 is configured to provide the previous call stack to debugger UI 204 in response to debugging agent 208 indicating that the first hash matches a second hash of thread registers of debuggee process 210 and stack memory of the current call stack.

In one embodiment, debugger backend 202 is configured to compute the current call stack and provide the current call stack to debugger UI 204 based on current call stack information provided from debugging agent 208 and in response to debugging agent 208 indicating that the first hash does not match the second hash. In one embodiment, debugger backend 202 stores (e.g., caches) the computed current call stack.

In one embodiment, debugging agent 208 is configured to receive, from debugger backend 202, the first hash of thread registers of debuggee process 210 and stack memory of the previous call stack of multiple threads of debuggee process 210. In response to receiving the first hash from debugger backend 202, debugging agent 208 reads thread registers of debuggee process 210 and stack memory of the current call stack of multiple threads of debuggee process 210. Debugging agent 208 is configured to compute a second hash of thread registers of debuggee process 210 and stack memory of the current call stack.

In one embodiment, debugging agent 208 is configured to compare the first hash to the second hash and provide an indication to debugger backend 202 of whether or not the first hash matches the second hash. In one embodiment, if the first hash does not match the second hash, debugging agent 208 provides current call stack information to debugger backend 202 to permit debugger backend 202 to compute the current call stack. In one embodiment, if the first hash matches the second hash, debugging agent 208 does not provide current call stack information to debugger backend 202, because debugger backend 202 has cached the previous call stack of multiple threads of debugger process 210 and the match of the first hash to the second hash indicates that the previous call stack is still valid.

In the above scenario, the first hash matching the second hash indicates that the corresponding thread of debuggee process 210 has not moved since the call stack was last walked by the user. Therefore, the previous computed call stack is provided from debugger backend 202 to debugger UI 204 as it represents the equivalent current call stack. If the structure of debuggee process 210 is somewhat complicated, a complicated stack walk may be employed in the debugging of the debuggee process 210. In such a scenario, embodiments can provide a significant savings in time and computer resources of debugger system application 200. Even though debugging agent 208 still reads the call stack of debuggee process 210, this reading of the call stack is only a small portion of the time and computer resources employed for a stack walk. In the embodiment where debugger system computer 100 and a debuggee process computer 206 are remote devices, only the first hash is transferred between debugger system computer 100 and debuggee process computer 206 in the scenario where the first hash matches the second hash.

In one embodiment, debugging agent 208 computes the first hash of thread registers of debuggee process 210 and stack memory of the previous call stack and provides the first hash to debugger backend 202, which is then stored by debugger backend 202.

In one embodiment, debugging agent 208 is configured to compute the first hash based on a total stack memory of the previous call stack, and compute the second hash based on a total stack memory of the current call stack. In another embodiment, in order to reduce the size of the hash, debugging agent 208 is configured compute the first hash based on only a portion of a total stack memory of the previous call stack, and compute the second hash based on a portion of a total stack memory of the current call stack. In one embodiment, this portion (i.e., subset) of the total stack memory is a leaf-most subset. In this embodiment, debugging agent 208 computes the hash with a selected maximum amount of stack memory, wherein the hash is computed from the leaf-most part of the call stack to the start of the call stack or to reaching the selected maximum amount of stack memory. In one example implementation of this embodiment, the selected maximum amount of stack memory is a selected constant value (e.g., 4096 bytes). In one example implementation of this embodiment, the selected maximum amount of stack memory is a value computed as part of the previous stack walk (e.g., the amount of stack memory used to store the top 40 frames).

As mentioned above, in one embodiment, debugger system application 200 is implemented on a debugger system computer 100 and debugging agent 208 and/or debuggee process 210 are implemented on a debugge process computer which is separate and possibly remote from the debugger system computer. In other embodiments, debugger system application 200 is implemented on a computer that also implements the debugging agent 208 and/or debuggee process 210.

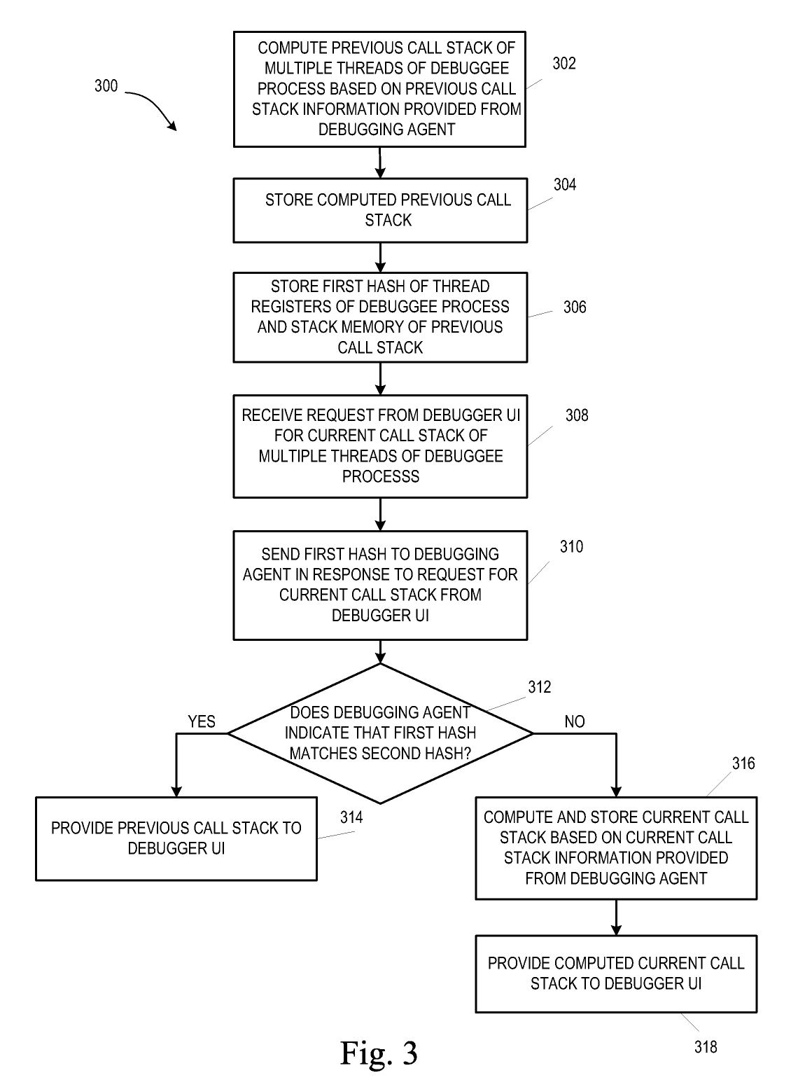

One embodiment of a method 300 performed by a debugger backend of a debugger system application (e.g., debugger backend 202 of debugger system application 200) is illustrated in flow diagram form in FIG. 3. At 302, the debugger backend computes the previous call stack of multiple threads of a debuggee process (e.g., debuggee process 210) based on previous call stack information provided from a debugging agent (e.g., debugging agent 208). At 304, the debugger backend stores the computed previous call stack. At 306, the debugger backend stores a first hash of the thread registers of the debuggee process and stack memory of the previous call stack.

At 308, the debugger backend receives a request from a debugger UI (e.g., debugger UI 204 of debugger system application 200) for the current call stack of multiple threads of the debuggee process. At 310, the debugger backend sends the stored first hash to the debugging agent in response to the request for the current call stack from the debugger UI.

At 312, the debugger backend receives an indication from the debugging agent as to whether the first hash matches a second hash of thread registers of the debuggee process and stack memory of the current call stack. At 314, if the first hash matches the second hash, the debugger backend provides the stored computed previous call stack to the debugger UI.

At 316, if the first hash does not match the second hash, the debugger backend computes and stores the current call stack based on current call stack information provided from the debugging agent. At 318, the debugger backend provides the computed current call stack to the debugger UI.

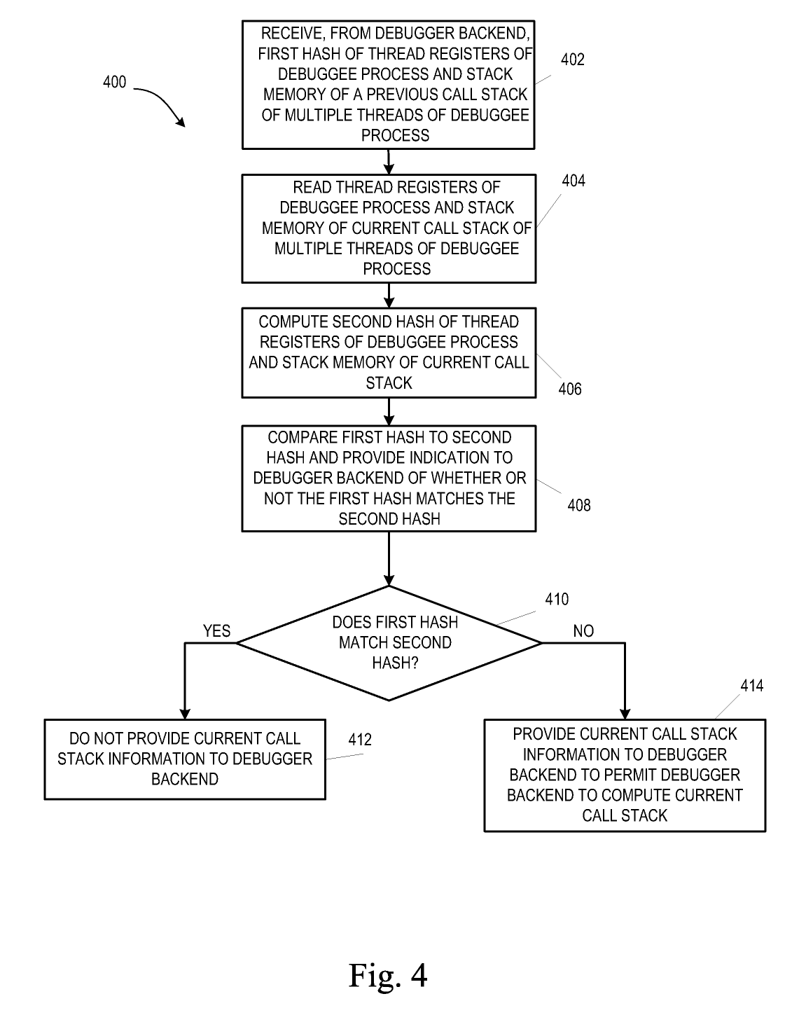

One embodiment of a method 400 performed by a debugging agent (e.g., debugging agent 208) is illustrated in flow diagram form in FIG. 4. At 402, the debugging agent receives from a debugger backend (e.g., debugger backend 202 of debugger system application 200) a first hash of thread registers of a debuggee process (e.g., debuggee process 210) and stack memory of a previous call stack of multiple threads of the debuggee process. At 404, the debugging agent reads the thread registers of the debuggee process and stack memory of the current call stack of the multiple threads of the debuggee process in response to receiving the first hash from the debugger backend.

At 406, the debugging agent computes a second hash of thread registers of the debuggee process and stack memory of the current call stack. At 408, the debugging agent compares the first hash to the second hash and provides an indication to the debugger backend of whether or not the first hash matches the second hash.

At 410, different actions are performed by the debugging agent depending on whether or not the first hash matches the second hash. At 412, if the first hash matches the second hash, the debugging agent does not provide the current call stack information to the debugger backend, because as discussed above, in this scenario the previous call stack, which was computed and stored by the debugger backend, is still valid. If the first hash does not match the second hash, the debugging agent provides current call stack information to the debugger backend to permit the debugger backend to compute the current call stack, because in this scenario the previous call stack, which was computed and stored by the debugger backend, is no longer valid.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of debugging a debuggee process, the method comprising:
computing a previous call stack of multiple threads of the debuggee process based on previous call stack information provided from a debugging agent;
storing the computed previous call stack;
storing a first hash of thread registers of the debuggee process and stack memory of the previous call stack;
receiving a request from a debugger user interface (UI) for a current call stack of multiple threads of the debuggee process;
sending the first hash to the debugging agent in response to the request of the current call stack from the debugger UI; and
providing the previous call stack to the debugger UI in response to the debugging agent indicating that the first hash matches a second hash of thread registers of the debuggee process and stack memory of the current call stack.

2. The method of claim 1 comprising:
computing the current call stack based on current call stack information provided from the debugging agent and in response to the debugging agent indicating that the first hash does not match the second hash.

3. The method of claim 2 comprising:
providing the computed current call stack to the debugger UI.

4. The method of claim 2 comprising:
storing the computed current call stack.

5. The method of claim 1 comprising:
computing, at a debugger backend, the first hash of thread registers of the debuggee process and stack memory of the previous call stack.

6. The method of claims 1 comprising:
receiving, at a debugger backend from the debugging agent, the first hash of thread registers of the debuggee process and stack memory of the previous call stack from the debugging agent.

7. The method of claim 1 wherein the first hash is based on a portion of a total stack memory of the previous call stack and the second hash is based on a portion of a total stack memory of the current call stack.

8. The method of claim 1 wherein the first hash is based on a total stack memory of the previous call stack and the second hash is based on a total stack memory of the current call stack.

9. The method of claim 1 wherein the method is performed in a first computer remote from a second computer running the debugging agent.

10. The method of claim 1 wherein the method is performed in a first computer and the first computer runs the debugging agent.

11. A debugger system comprising:
a debugger user interface (UI) configured to allow a user to interact with the debugger system and request a current call stack of multiple threads of a debuggee process; and
a debugger backend configured to:
compute and store a previous call stack of multiple threads of the debuggee process based on previous call stack information provided from a debugging agent;
store a first hash of thread registers of the debuggee process and stack memory of the previous call stack;
send the first hash to the debugging agent in response to the request of the current call stack from the debugger UI; and
provide the previous call stack to the debugger UI in response to the debugging agent indicating that the first hash matches a second hash of thread registers of the debuggee process and stack memory of the current call stack.

12. The debugger system of claim 11 wherein the debugger backend is configured to compute and store the current call stack and provide the current call stack to the debugger UI based on current call stack information provided from the debugging agent and in response to the debugging agent indicating that the first hash does not match the second hash.

13. The debugger system of claim 11 wherein the debugger backend is configured to compute the first hash of thread registers of the debuggee process and stack memory of the previous call stack.

14. The debugger system of claim 11 wherein the debugger backend is configured to receive the first hash of thread registers of the debuggee process and stack memory of the previous call stack from the debugging agent.

15. A computer readable storage medium storing computer-executable instructions for controlling a computer system to perform a method comprising:
receiving, from a debugger backend, a first hash of thread registers of a debuggee process and stack memory of a previous call stack of multiple threads of the debuggee process;
reading thread registers of the debuggee process and stack memory of a current call stack of multiple threads of the debuggee process;
computing a second hash of thread registers of the debuggee process and stack memory of the current call stack; and
comparing the first hash to the second hash and providing an indication to the debugger backend of whether or not the first hash matches the second hash.

16. The computer readable storage medium of claim 15 wherein the method comprises:
providing current call stack information to the debugger backend to permit the debugger backend to compute the current call stack if the first hash does not match the second hash.

17. The computer readable storage medium of claim 15 wherein the method comprises:
not providing current call stack information to the debugger backend if the first hash matches the second hash.

18. The computer readable storage medium of claim 15 wherein the method comprises:
computing the first hash of thread registers of the debuggee process and stack memory of the previous current call stack; and
providing the first hash to the debugger backend.

19. The computer readable storage medium of claim of 15 wherein the method comprises:
computing the first hash based on a portion of a total stack memory of the previous call stack; and
computing the second hash based on a portion of a total stack memory of the current call stack.

20. The computer readable storage medium of claim of 15 wherein the method comprises:
computing the first hash based on a total stack memory of the previous call stack; and
computing the second hash based on a total stack memory of the current call stack.
